(19) United States
(12) Patent Application Publication
(10) Pub. No.: US 2025/0239184 A1
(43) Pub. Date: Jul. 24, 2025

(54) VOCAL CORD TRAUMA FOR PATIENT SIMULATORS

(71) Applicant: GAUMARD SCIENTIFIC COMPANY, INC., Miami, FL (US)

(72) Inventor: Karina ZORNOZA, Miami, FL (US)

(21) Appl. No.: 19/030,618

(22) Filed: Jan. 17, 2025

Related U.S. Application Data
(60) Provisional application No. 63/623,185, filed on Jan. 19, 2024.

(51) Int. Cl. G09B 23/34

(52) U.S. Cl. CPC G09B 23/34

(57) ABSTRACT

Simulated vocal cord inserts for patient simulators and associated devices, systems, and methods are provided. In some instances, a patient simulator comprises a simulated head; a simulated neck coupled to the simulated head; a simulated healthy vocal cord assembly positioned within at least one of the simulated head or the simulated neck; and a simulated abnormal vocal cord assembly configured to be selectively engage with the simulated healthy vocal assembly.

### CROSS-REFERENCE TO RELATED APPLICATIONS

The present application claims priority to and the benefit of U.S. Provisional Patent Application No. 63/623,185, filed Jan. 19, 2024, which is hereby incorporated by reference in its entirety for all applicable purposes.

### INTRODUCTION

The present disclosure relates generally to patient simulators. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. Pat. No. 11,756,451, U.S. Pat. No. 8,696,362, U.S. Pat. No. 8,016,598, U.S. Pat. No. 7,976,312, U.S. Pat. No. 7,976,313, U.S. patent application Ser. No. 11/952,669 (Publication No. 20090148822), U.S. Pat. No. 7,114,954, U.S. Pat. No. 6,758,676, U.S. Pat. No. 6,503,087, U.S. Pat. No. 6,527,558, U.S. Pat. No. 6,443,735, U.S. Pat. No. 6,193,519, and U.S. Pat. No. 5,853,292, each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

This disclosure describes vocal cord trauma, including associated inserts and/or overlays, for patient simulators. In this regard, the vocal cord assemblies of the current disclosure can provide realistic simulation of damaged vocal cords from physical trauma, chemical trauma/burns, inflammation from thermal inhalation, and/or other characteristics of damaged vocal cords. In some instances, a plurality of different vocal cord assemblies are provided with different levels and/or types of simulated trauma. For example, for vocal cords there are several degrees of increasing inhalation injury/burn with classification Grades I-IV. These grades indicate the severity of injury and/or obstruction in airway (Grade 0—no injury, no obstruction (e.g., healthy vocal cords), Grade II—moderate, obstruction from 35%-50%, and Grade IV—severe, obstruction from 76%-100%). In some instances, one or more vocal cord assemblies simulating the various classification grades and/or different types traumas within a single (or multiple) classifications may be provided. In this regard, the vocal cord assemblies may be selectively inserted into a patient simulator to simulate the different types and classifications of vocal cord trauma. The vocal cord assemblies may be utilized to train users on identifying the type and/or classification of vocal cord trauma and applying appropriate treatment options.

In some aspects, a patient simulator comprises: a simulated head; a simulated neck coupled to the simulated head; a simulated healthy vocal cord assembly positioned within at least one of the simulated head or the simulated neck; and a simulated abnormal vocal cord assembly configured to be selectively engage with the simulated healthy vocal assembly. The simulated abnormal vocal cord assembly may include a body having a simulated vocal cord portion simulating natural vocal cords that have been subject to trauma. The vocal cord portion may include a central opening narrower than a central opening of the simulated healthy vocal cord assembly. The simulated vocal cord portion may further include a color and/or a texture simulating the natural vocal cords that have been subject to trauma. The color and/or the texture of the simulated vocal cord portion may be different than a corresponding color and/or texture of the simulated healthy vocal cord assembly. The simulated abnormal vocal cord assembly may include a body and a support structure within the body. The body and the simulated vocal cord portion of the simulated abnormal vocal cord assembly may be formed of a more flexible material than the support structure. For example, the body and the simulated vocal cord portion may be formed of silicone and the support structure may be formed of a more rigid plastic. The simulated abnormal vocal cord assembly may simulates a Grade I, Grade II, Grade III, Grade IV, or other vocal cord trauma. The simulated healthy vocal cord assembly may be fixedly integrated into at least one of the simulated head or the simulated neck. The simulated healthy vocal cord assembly may be removably coupled to at least one of the simulated head or the simulated neck.

In some aspects, a plurality of vocal cord assemblies for use with a patient simulator comprises: a first simulated abnormal vocal cord assembly configured to selectively engage with a simulated healthy vocal assembly of the patient simulator, the first simulated abnormal vocal cord assembly simulating a first vocal cord trauma; and a second simulated abnormal vocal cord assembly configured to selectively engage with the simulated healthy vocal assembly of the patient simulator, the second simulated abnormal vocal cord assembly simulating a second vocal cord trauma different than the first vocal cord trauma. Each of the first and second simulated abnormal vocal cord assemblies may include a simulated vocal cord portion having a central opening narrower than a central opening of the simulated healthy vocal cord assembly. The simulated vocal cord portion of the first simulated abnormal vocal cord assembly may further include a color and/or a texture simulating the first vocal cord trauma. The color and/or the texture of the simulated vocal cord portion of the first simulated abnormal vocal cord assembly may be different than a corresponding color and/or texture of the simulated healthy vocal cord assembly. Similarly, the simulated vocal cord portion of the second simulated abnormal vocal cord assembly may further include a color and/or a texture simulating the second vocal cord trauma. The color and/or the texture of the simulated vocal cord portion of the second simulated abnormal vocal cord assembly may be different than a corresponding color and/or texture of the simulated healthy vocal cord assembly. The first vocal cord trauma may be a Grade I, Grade II, Grade III, Grade IV, or other vocal cord trauma and the second vocal cord trauma may be a Grade I, Grade II, Grade III, Grade IV, or other vocal cord trauma. Each of the first and second simulated abnormal vocal cord assemblies may include a body and a support structure within the body, wherein the body is formed of a more flexible material than the support structure. The body may be formed of silicone and the support structure may be formed of a more rigid plastic.

Methods of using the plurality of vocal cord assemblies with a patient simulator are also provided. In this regard, a plurality of vocal cord assemblies simulating various classification grades and/or different types of vocal cord trauma may be provided and selectively interchanged.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective view of a patient simulator including a simulated torso, a simulated head, a simulated neck, a simulated right arm, a simulated left arm, a simulated right leg, and a simulated left leg, including at least one vocal cord assembly according to one or more aspects of the present disclosure.

FIG. 2 is a perspective view of a vocal cord assembly, according to one or more aspects of the present disclosure.

FIG. 3 is a top view of a healthy vocal cord assembly, according to one or more aspects of the present disclosure.

FIG. 4 is a top view of a damaged vocal cord assembly coupled with a healthy vocal cord assembly, according to one or more aspects of the present disclosure.

FIG. 5 is a side view of the damaged vocal cord assembly coupled with the healthy vocal cord assembly and positioned within a patient simulator, according to one or more aspects of the present disclosure.

FIG. 6 is similar to FIG. 5 but provides a closer-up side view of the damaged vocal cord assembly coupled with the healthy vocal cord assembly and positioned within the patient simulator, according to one or more aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts.

One of the aims of healthcare simulation is to establish a teaching environment that closely mimics key clinical cases in a reproducible manner. The introduction of high fidelity tetherless simulators, such as those available from Gaumard Scientific Company, Inc., over the past few years has proven to be a significant advance in creating realistic teaching environments. The present disclosure is directed to a patient simulator that expands the functionality of the simulators by increasing the realism of the look, feel, and functionality of the simulators that can be used to train medical personnel in a variety of clinical situations. The patient simulator disclosed herein offers a training platform on which medical scenarios can be performed for the development of medical treatment skills and the advancement of patient safety. Accordingly, the user's medical treatment skills can be obtained and/or improved in a simulated environment without endangering a live patient. Moreover, the patient simulator allows for multiple users to simultaneously work with the patient simulator during a particular medical scenario, thereby facilitating team training and assessment in a realistic, team-based environment.

In several aspects, the patient simulator includes features designed to enhance the educational experience. For example, in several aspects, the system includes a processing module to simulate different medical and/or surgical scenarios during operation of the patient simulator. In several aspects, the system includes a camera system that allows visualization of the procedure for real-time video and log capture for debriefing purposes. In several aspects, the patient simulator is provided with a workbook of medical scenarios that are pre-programmed in an interactive software package, thereby providing a platform on which medical scenarios can be performed for the development of medical treatment skills and general patient safety. Thus, the patient simulators disclosed herein provide a system that is readily expandable and updatable without large expense and that enables users to learn comprehensive medical and surgical skills through “hands-on” training, without sacrificing the experience gained by users in using standard surgical instruments in a simulated patient treatment situation.

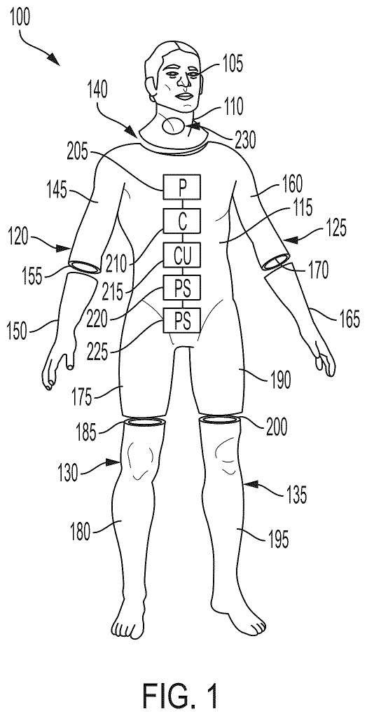

Referring to FIG. 1, in some aspects, a patient simulator is generally referred to by the reference numeral 100 and includes a simulated head 105, a simulated neck 110, a simulated torso 115, a simulated right arm 120 (or “extremity”), a simulated left arm 125 (or “extremity”), a simulated right leg 130 (or “extremity”), and a simulated left leg 135 (or “extremity”). In several embodiments, the patient simulator is, includes, or is part of, a manikin. The simulated head 105 may be coupled to the simulated neck 110. For example, the simulated head 105 may be integrally formed with and/or detachably coupled to the simulated neck 110. The patient simulator 100 may further include a head coupling 140. The simulated neck 110 may be adapted to be detachably coupled to the simulated torso 115 via the head coupling 140. In some aspects, the simulated right arm 120 includes a simulated upper right arm 145 (or “extremity”) and a simulated lower right arm 150 (or “extremity”). The simulated upper right arm 145 may be coupled to the simulated torso 115. For example, the simulated upper right arm 145 may be integrally formed with and/or detachably coupled to the simulated torso 115. The simulated right arm 120 may further include a right arm coupling 155 (or “extremity coupling”). The simulated lower right arm 150 may be detachably coupled to the simulated upper right arm 145 via the right arm coupling 155. Similarly, the simulated left arm 125 may include a simulated upper left arm 160 (or “extremity”) and a simulated lower left arm 165 (or “extremity”). The simulated upper left arm 160 may be coupled to the simulated torso 115. For example, the simulated upper left arm 160 may be integrally formed with and/or detachably coupled to the simulated torso 115. The simulated left arm 125 may further include a left arm coupling 170 (or “extremity coupling”). The simulated lower left arm 165 may be detachably coupled to the simulated upper left arm 160 via the left arm coupling 170.

The simulated right leg 130 may include a simulated upper right leg 175 (or “extremity”) and a simulated lower right leg 180 (or “extremity”). The simulated upper right leg 175 may be coupled to the simulated torso 115. For example, the simulated upper right leg 175 may be integrally formed with and/or detachably coupled to the simulated torso 115. The simulated right leg 130 may further include a right leg coupling 185 (or “extremity coupling”). The simulated lower right leg 180 may be detachably coupled to the simulated upper right leg 175 via the right leg coupling 185. Similarly, the simulated left leg 135 may include a simulated upper left leg 190 (or “extremity”) and a simulated lower left leg 195 (or “extremity”). The simulated upper left leg 190 may be coupled to the simulated torso 115. For example, the simulated upper left leg 190 may be integrally formed with and/or detachably coupled to the simulated torso 115. The simulated left leg 135 may further include a left leg coupling 200 (or “extremity coupling”). The simulated lower left leg 195 may be detachably coupled to the simulated upper left leg 190 via the left leg coupling 200.

In some instances, the simulated torso 115 may be divided into a simulated upper torso and a simulated lower torso. In such instances, the simulated upper right arm 145 and the simulated upper left arm 160 may be coupled to the simulated upper torso. For example, the simulated upper right arm 145 and the simulated upper left arm 160 may be integrally formed with and/or detachably coupled to the simulated upper torso. The simulated upper right leg 175 and the simulated upper left leg 190 may be coupled to the simulated lower torso. For example, the simulated upper right leg 175 and the simulated upper left leg 190 may be integrally formed with and/or detachably coupled to the simulated lower torso. The simulated torso 115 may further includes a torso coupling via which the simulated upper torso may be detachably coupled to the simulated lower torso.

The simulated torso 115 (as well as the simulated head 105, simulated neck 110, simulated right arm 120, simulated left arm 125, a simulated right leg 130, and/or simulated left leg 135) may contain one or more pump(s) 205, compressor(s) 210, control unit(s) 215, reservoir(s) 220, power source(s) 225, and/or other components. The pump(s) 205 may be adapted to supply hydraulic pressure to various features/components of the patient simulator 100. The features/components to which hydraulic pressure is supplied by the pump(s) 205 may be contained in the simulated torso 115, the simulated head 105, the simulated right arm 120, the simulated left arm 125, the simulated right leg 130, and/or the simulated left leg 135. In some instances, the pump(s) 205 may supply hydraulic pressure to one or more of the reservoir(s) 220. For example, the pump(s) 205 may cause fluid to be transferred into and/or out of one or more of the reservoir(s) 220. In this regard, the reservoir(s) 220 may contain fluid and/or gas.

The compressor(s) 210 may be adapted to supply pneumatic pressure to various features/components of the patient simulator 100. The features/components to which pneumatic pressure is supplied by the compressor(s) 210 may be contained in the simulated torso 115, the simulated head 105, the simulated right arm 120, the simulated left arm 125, the simulated right leg 130, and/or the simulated left leg 135. In some instances, the compressor(s) 210 may include a scroll compressor. In some instances, the compressor(s) 210 may supply pneumatic pressure to one or more of the reservoir(s) 220. In this regard, the reservoir(s) 220 may contain fluid and/or gas.

The control unit(s) 215 may be adapted to control the pump(s) 205, the compressor(s) 210, the reservoir(s) 220, including one or more valves associated with the pump(s), compressor(s), and/or reservoir(s), and/or various other features/components of the patient simulator 100. The features/components controlled by the control unit(s) 215 may be contained in the simulated torso 115, the simulated head 105, the simulated right arm 120, the simulated left arm 125, the simulated right leg 130, and/or the simulated left leg 135. In some instances, each of the control unit(s) 215 may be associated with one or more functions and/or features of the patient simulator 100.

The reservoir(s) 220 may contain fluid and/or gas for use in simulating one or more scenarios, functions, and/or features. For example, the reservoir(s) 220 may contain simulated bodily fluids (e.g., blood, urine, saliva, tears, etc.) and/or simulated bodily gasses (e.g., air, O₂, CO₂, etc.). The reservoir(s) 220 may include a single compartment or multiple compartments. The reservoir(s) 220 may be associated with one or more valves to control the flow of fluid and/or gas into and/or out of the reservoir(s) 220.

The power source(s) 225 may supply electrical power to the pump(s) 205, the compressor(s) 210, the control unit(s) 215, the reservoir(s) 220, including one or more valves associated with the pump(s), compressor(s), and/or reservoir(s), and various other features/components of the patient simulator 100. The features/components to which electrical power is supplied by the power source(s) 225 may be contained in the simulated torso 115, the simulated head 105, the simulated right arm 120, the simulated left arm 125, the simulated right leg 130, and/or the simulated left leg 135. The features/components to which electrical power is supplied by the power source(s) 225 may be contained in a different portion of the patient simulator 100 than the power source(s) 225. In some aspects, the power source(s) 225 includes lithium battery technology that reduces weight, volume, and complexity while providing greater power density. However, any suitable battery technology may be used in accordance with the present disclosure, including without limitation lithium, lithium-ion, lithium-sulfur, lithium manganese oxide, lithium polymer, lithium titanate, lithium cobalt oxide, lithium iron phosphate, nickel metal hydride, nickel-cadmium, alkaline, supercapacitor, sodium-ion, magnesium, etc.

In some instances, the power source(s) 225 may be positioned within one or more extremities (e.g., the simulated right arm 120, the simulated left arm 125, the simulated right leg 130, and/or the simulated left leg 135) of the patient simulator 100. In this regard, an extremity containing the power source(s) 225 may be detachably coupled to the simulated torso 115. In some aspects, the extremity containing the power source(s) 225 may include a quick-connect connector to facilitate simple and/or fast power system changes (e.g., by swapping an extremity with a depleted power source for an extremity with a charged power source). In this regard, the quick-connect connector may physically couple the extremity to the simulated torso 115 and/or another aspect of the patient simulator 100 (e.g., upper and/or lower arm, upper and/or lower leg, etc.). The quick-connect connector may also electrically couple the power source(s) 225 contained in the extremity to one or more components of the patient simulator 100 (e.g., the pump(s) 205, the compressor(s) 210, the control unit(s) 215, the reservoir(s) 220, including one or more valves associated with the pump(s), compressor(s), and/or reservoir(s), and various other features/components). In some aspects, the quick-connect connector may also pneumatically and/or fluidly couple one or more components (e.g., pump(s) 205, compressor(s) 210, reservoir(s) 220, valve(s), and other pneumatic and/or fluid components) contained in the extremity (along with the power source(s) 225) to one or more other components of the patient simulator 100 (e.g., the pump(s) 205, the compressor(s) 210, the reservoir(s) 220, valve(s), and various other features/components).

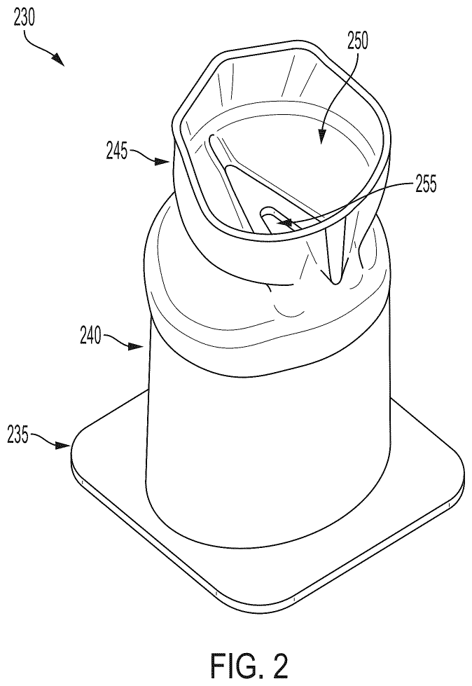

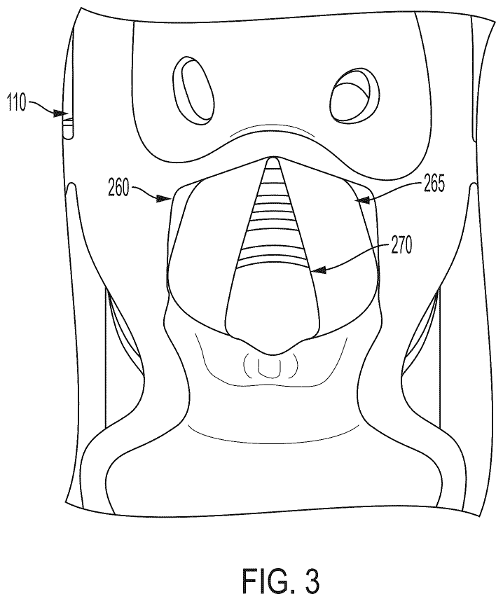

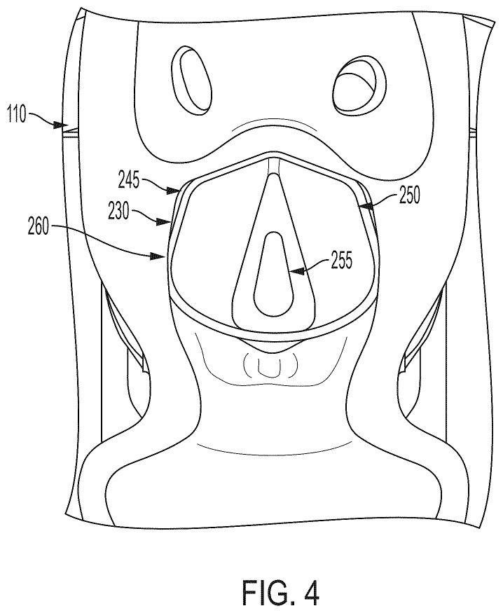

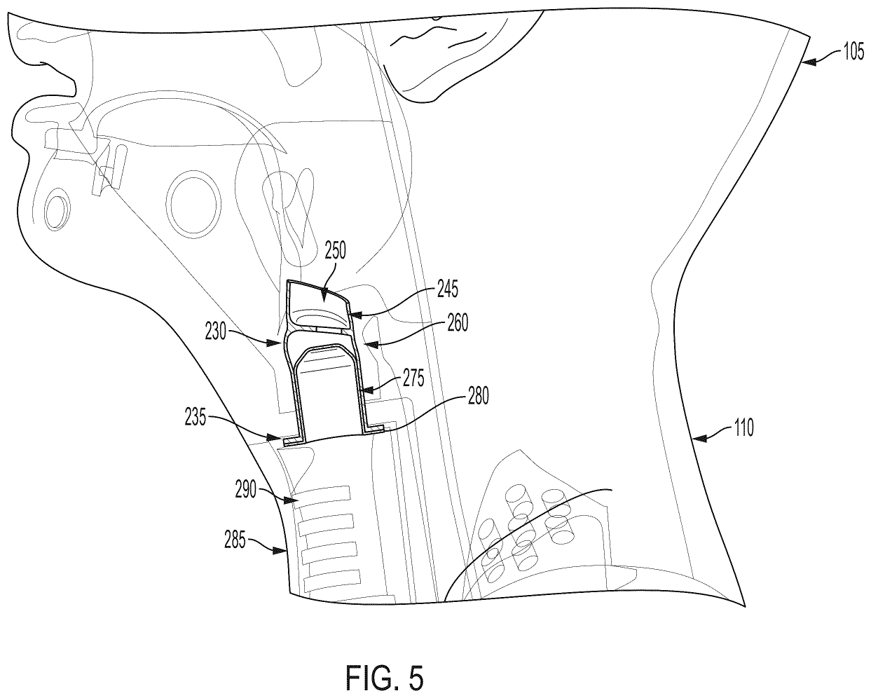

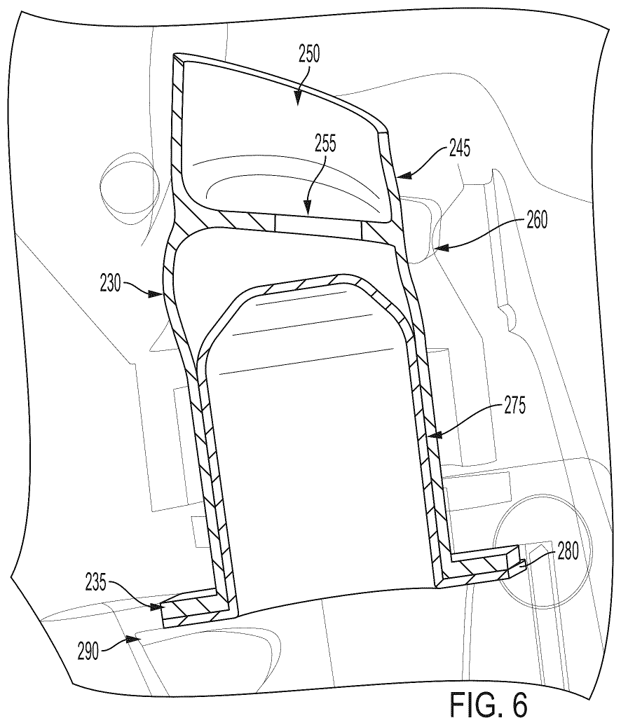

Referring to FIGS. 2-6 and continuing reference to FIG. 1, the patient simulator 100 includes one or more vocal cord assemblies 230. For example, FIG. 2 is a perspective view of a vocal cord assembly 230, according to one or more aspects of the present disclosure. FIG. 3 is a top view of a healthy vocal cord assembly 260, according to one or more aspects of the present disclosure. FIG. 4 is a top view of a damaged vocal cord assembly 230 coupled with a healthy vocal cord assembly 260, according to one or more aspects of the present disclosure. FIG. 5 is a side view of the damaged vocal cord assembly 230 coupled with the healthy vocal cord assembly 260 and positioned within a patient simulator 100, according to one or more aspects of the present disclosure. FIG. 6 is similar to FIG. 5 but provides a closer-up side view of the damaged vocal cord assembly 230 coupled with the healthy vocal cord assembly 260 and positioned within the patient simulator 100, according to one or more aspects of the present disclosure.

The vocal cord assemblies, including associated inserts and/or overlays, are configured to simulate vocal cord trauma in the context of patient simulators. In this regard, the vocal cord assemblies may couple or mate with an existing healthy vocal cord assembly of the patient simulator. In other instances, the vocal cord assemblies simulating vocal cord trauma may replace or interchange with the healthy vocal cord assembly. The vocal cord assemblies of the current disclosure can provide realistic simulation of damaged vocal cords from physical trauma, chemical trauma/burns, inflammation from thermal inhalation, and/or other characteristics of damaged vocal cords. In some instances, a plurality of different vocal cord assemblies are provided with different levels and/or types of simulated trauma. For example, for vocal cords there are several degrees of increasing inhalation injury/burn with classification Grades I-IV. These grades indicate the severity of injury and/or obstruction in airway (Grade 0—no injury, no obstruction (e.g., healthy vocal cords), Grade II—moderate, obstruction from 35%-50%, and Grade IV—severe, obstruction from 76%-100%). In some instances, one or more vocal cord assemblies simulating the various classification grades and/or different types traumas within a single (or multiple) classifications may be provided. For example, the vocal cord assemblies may have different dimensions, textures, colors, and/or other features to simulate vocal cord trauma. In this regard, the vocal cord assemblies may be selectively inserted into a patient simulator to simulate the different types and classifications of vocal cord trauma. The vocal cord assemblies may be utilized to train users on identifying the type and/or classification of vocal cord trauma and applying appropriate treatment options.

As shown in FIG. 2, the vocal cord assembly 230 includes a base 235, a body 240, and a simulated vocal cord portion 245. The simulated vocal cord portion 245 may include a cavity or recess 250 and have a central opening 255 extending therethrough simulating natural vocal cords that have been subject to trauma. In this regard, the central opening 255 of the vocal cord assembly may be narrowed as compared to a healthy vocal assembly 260 shown in FIG. 3. In particular, as shown, the healthy vocal cord assembly 260 includes a cavity or recess 265 and a central opening 270 sized, shaped, colored, and/or textured to simulate healthy vocal cords. In contrast, the vocal cord portion 245 of the vocal cord assembly 230, including the cavity 250 and/or the central opening 255, may be sized, shaped, colored, and/or textured to simulate damaged vocal cords or vocal cords that have otherwise suffered trauma.

As shown in FIGS. 4-6, the vocal cord assembly 230 may be configured to engage with and/or be received within the healthy vocal cord assembly 260. The vocal cord assembly 230 may include a support structure 275 that extends within the body 240. The support structure 275 may also include or be coupled with a flange portion 280 that provides support to and/or defines the base 235 of the vocal cord assembly 230. In this regard, while the body 240 and simulated vocal cord portion 245 may be formed of silicon or other flexible material, the support structure 275 may be formed of a more rigid material, such as a plastic, carbon fiber, metal, rubber, other suitable material, and/or combinations thereof. As shown in FIGS. 5 and 6, the vocal cord assembly may be manually inserted within the healthy vocal cord assembly 260 through a trachea opening 285 or other opening in the neck 110 and/or the head 105 of the patient simulator 100. In some instances, engagement of a simulated trachea 290 or associated components with the base 235 and/or the support structure 275 serves to secure the vocal cord assembly 230 in place within the patient simulator 100, including within the healthy vocal cord assembly 260 in some instances.

In some aspects, a patient simulator comprises: a simulated head; a simulated neck coupled to the simulated head; a simulated healthy vocal cord assembly positioned within at least one of the simulated head or the simulated neck; and a simulated abnormal vocal cord assembly configured to be selectively engage with the simulated healthy vocal assembly. The simulated abnormal vocal cord assembly may include a body having a simulated vocal cord portion simulating natural vocal cords that have been subject to trauma. The vocal cord portion may include a central opening narrower than a central opening of the simulated healthy vocal cord assembly. The simulated vocal cord portion may further include a color and/or a texture simulating the natural vocal cords that have been subject to trauma. The color and/or the texture of the simulated vocal cord portion may be different than a corresponding color and/or texture of the simulated healthy vocal cord assembly. The simulated abnormal vocal cord assembly may include a body and a support structure within the body. The body and the simulated vocal cord portion of the simulated abnormal vocal cord assembly may be formed of a more flexible material than the support structure. For example, the body and the simulated vocal cord portion may be formed of silicone and the support structure may be formed of a more rigid plastic. The simulated abnormal vocal cord assembly may simulates a Grade I, Grade II, Grade III, Grade IV, or other vocal cord trauma. The simulated healthy vocal cord assembly may be fixedly integrated into at least one of the simulated head or the simulated neck. The simulated healthy vocal cord assembly may be removably coupled to at least one of the simulated head or the simulated neck.

In some aspects, a plurality of vocal cord assemblies for use with a patient simulator comprises: a first simulated abnormal vocal cord assembly configured to selectively engage with a simulated healthy vocal assembly of the patient simulator, the first simulated abnormal vocal cord assembly simulating a first vocal cord trauma; and a second simulated abnormal vocal cord assembly configured to selectively engage with the simulated healthy vocal assembly of the patient simulator, the second simulated abnormal vocal cord assembly simulating a second vocal cord trauma different than the first vocal cord trauma. Each of the first and second simulated abnormal vocal cord assemblies may include a simulated vocal cord portion having a central opening narrower than a central opening of the simulated healthy vocal cord assembly. The simulated vocal cord portion of the first simulated abnormal vocal cord assembly may further include a color and/or a texture simulating the first vocal cord trauma. The color and/or the texture of the simulated vocal cord portion of the first simulated abnormal vocal cord assembly may be different than a corresponding color and/or texture of the simulated healthy vocal cord assembly. Similarly, the simulated vocal cord portion of the second simulated abnormal vocal cord assembly may further include a color and/or a texture simulating the second vocal cord trauma. The color and/or the texture of the simulated vocal cord portion of the second simulated abnormal vocal cord assembly may be different than a corresponding color and/or texture of the simulated healthy vocal cord assembly. The first vocal cord trauma may be a Grade I, Grade II, Grade III, Grade IV, or other vocal cord trauma and the second vocal cord trauma may be a Grade I, Grade II, Grade III, Grade IV, or other vocal cord trauma. Each of the first and second simulated abnormal vocal cord assemblies may include a body and a support structure within the body, wherein the body is formed of a more flexible material than the support structure. The body may be formed of silicone and the support structure may be formed of a more rigid plastic.

Methods of using the plurality of vocal cord assemblies with a patient simulator are also provided. In this regard, a plurality of vocal cord assemblies simulating various classification grades and/or different types of vocal cord trauma may be provided and selectively interchanged.

The patient simulator with simulated vocal cord assemblies offers several significant advantages in medical training. Firstly, it provides a highly realistic training environment for medical professionals by incorporating both healthy and abnormal vocal cord assemblies, allowing for a comprehensive understanding of vocal cord anatomy and pathology. The ability to switch between healthy and abnormal vocal cord assemblies enables the simulation of various medical conditions, including different grades of vocal cord trauma (Grade I to Grade IV), which is crucial for training in a wide range of clinical scenarios. By simulating vocal cords that have been subject to trauma, the simulator helps medical professionals develop and refine their diagnostic skills, with differences in color, texture, and central opening between healthy and abnormal vocal cords providing essential visual and tactile cues for accurate diagnosis.

The use of flexible materials like silicone for the vocal cord portions and more rigid plastics for the support structures enhances the tactile realism of the simulator, mimicking the natural feel of human tissues and improving the hands-on experience for trainees, while maintaining robustness and reliability. Additionally, the option to have the healthy vocal cord assembly either fixedly integrated or removably coupled to the simulated head or neck of the patient simulator adds flexibility by allowing for easy replacement and maintenance of the components. The ability to replicate various grades of vocal cord trauma provides a comprehensive training tool for medical professionals, particularly beneficial for preparing practitioners to handle a wide range of clinical situations involving vocal cord injuries. Ultimately, by offering a detailed and realistic training experience, the vocal cord assemblies of the present disclosure contribute to improved patient outcomes, as medical professionals who train with such advanced simulators are better equipped to diagnose and treat vocal cord conditions effectively.

Although illustrative embodiments have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the embodiment. Accordingly, it is appropriate that the appended claims be construed broadly and in a manner consistent with the scope of the present disclosure.

1. A patient simulator, comprising:
a simulated head;
a simulated neck coupled to the simulated head;
a simulated healthy vocal cord assembly positioned within at least one of the simulated head or the simulated neck; and
a simulated abnormal vocal cord assembly configured to be selectively engage with the simulated healthy vocal assembly.

2. The patient simulator of claim 1, wherein the simulated abnormal vocal cord assembly includes a body having a simulated vocal cord portion simulating natural vocal cords that have been subject to trauma.

3. The patient simulator of claim 2, wherein the vocal cord portion includes a central opening narrower than a central opening of the simulated healthy vocal cord assembly.

4. The patient simulator of claim 3, wherein the simulated vocal cord portion further includes a color and/or a texture simulating the natural vocal cords that have been subject to trauma.

5. The patient simulator of claim 4, wherein the color and/or the texture of the simulated vocal cord portion is different than a corresponding color and/or texture of the simulated healthy vocal cord assembly.

6. The patient simulator of claim 1, wherein the simulated abnormal vocal cord assembly includes a body and a support structure within the body.

7. The patient simulator of claim 6, wherein the body and the simulated vocal cord portion of the simulated abnormal vocal cord assembly are formed of a more flexible material than the support structure.

8. The patient simulator of claim 7, wherein the body and the simulated vocal cord portion are formed of silicone and the support structure is formed of a plastic.

9. The patient simulator of claim 1, wherein the simulated abnormal vocal cord assembly simulates a Grade II vocal cord trauma.

10. The patient simulator of claim 1, wherein the simulated abnormal vocal cord assembly simulates a Grade IV vocal cord trauma.

11. The patient simulator of claim 1, wherein the simulated healthy vocal cord assembly is fixedly integrated into at least one of the simulated head or the simulated neck.

12. The patient simulator of claim 1, wherein the simulated healthy vocal cord assembly is removably coupled to at least one of the simulated head or the simulated neck.

13. A plurality of vocal cord assemblies for use with a patient simulator, the plurality of vocal cord assemblies comprising:
a first simulated abnormal vocal cord assembly configured to selectively engage with a simulated healthy vocal assembly of the patient simulator, the first simulated abnormal vocal cord assembly simulating a first vocal cord trauma; and
a second simulated abnormal vocal cord assembly configured to selectively engage with the simulated healthy vocal assembly of the patient simulator, the second simulated abnormal vocal cord assembly simulating a second vocal cord trauma different than the first vocal cord trauma.

14. The plurality of vocal cord assemblies of claim 13, wherein each of the first and second simulated abnormal vocal cord assemblies includes a simulated vocal cord portion having a central opening narrower than a central opening of the simulated healthy vocal cord assembly.

15. The plurality of vocal cord assemblies of claim 14, wherein:
the simulated vocal cord portion of the first simulated abnormal vocal cord assembly further includes a color and/or a texture simulating the first vocal cord trauma; and
the simulated vocal cord portion of the second simulated abnormal vocal cord assembly further includes a color and/or a texture simulating the second vocal cord trauma.

16. The plurality of vocal cord assemblies of claim 15, wherein:
the color and/or the texture of the simulated vocal cord portion of the first simulated abnormal vocal cord assembly is different than a corresponding color and/or texture of the simulated healthy vocal cord assembly; and
the color and/or the texture of the simulated vocal cord portion of the second simulated abnormal vocal cord assembly is different than a corresponding color and/or texture of the simulated healthy vocal cord assembly.

17. The plurality of vocal cord assemblies of claim 16, wherein the first vocal cord trauma is a Grade II vocal cord trauma and the second vocal cord trauma is a Grade IV vocal cord trauma.

18. The plurality of vocal cord assemblies of claim 13, wherein each of the first and second simulated abnormal vocal cord assemblies includes a body and a support structure within the body, wherein the body is formed of a more flexible material than the support structure.

19. The plurality of vocal cord assemblies of claim 18, wherein the body is formed of silicone and the support structure is formed of a plastic.
